(19) United States
(12) Patent Application Publication
(10) Pub. No.: US 2025/0245575 A1
(43) Pub. Date: Jul. 31, 2025

(54) SYSTEMS AND METHODS FOR CONSTRUCTION AND RETRAINING OF DECISION TREES ENSEMBLE USING HYBRID CLASSICAL-QUANTUM ALGORITHMS

(71) Applicant: JPMORGAN CHASE BANK, N.A., New York, NY (US)

(72) Inventors: Romina YALOVETZKY, Buenos Aires (AR); Niraj KUMAR, Amsterdam (NL); Pierre MINSSEN, New York, NY (US); Changhao LI, Amawalk, NY (US); Marco PISTOIA, New York, NY (US)

(21) Appl. No.: 18/427,223

(22) Filed: Jan. 30, 2024

(51) Int. Cl. G06N 20/20

(52) U.S. Cl. CPC G06N 20/20

(57) ABSTRACT

Systems and methods for construction and retraining of decision trees ensemble using hybrid classical-quantum algorithms are disclosed. A method may include a classical computer program: receiving a dataset; calculating feature-weights for original examples using a feature-weight calculation method; updating the feature-weights for the original examples with feature-weights for the original examples and the new examples; loading the feature-weights for the dataset and new data into a first quantum-accessible data structure and loading overwritten values into a second quantum-accessible data structure; instructing a quantum computer to query quantum states for the first and second quantum-accessible data structures using random sampling with replacement, to execute quantum-supervised clustering with the quantum states and the feature-weights, to grow a depth for the tree, and to calculate labels for a regression task and/or a classification task; and receiving the labels from the quantum computer.

### BACKGROUND OF THE INVENTION

### 1. Field of the Invention

Embodiments relate to systems and methods for construction and retraining of decision trees ensemble using hybrid classical-quantum algorithms.

### 2. Description of the Related Art

The ability to train a machine learning (ML) model with large datasets has many benefits. One of them is in terms of accuracy maximization. For example, it has been shown that halving the size of the training set produces a statistically significant decrease in accuracy. Another important reason of why it is important that ML models scale to large data is the need for retraining with large datasets. In practice, in many applications, such as credit card and merchant payments, there is access to N_{new} (or N_{new}) labeled examples (i.e., N new examples that have been labeled) that may be used to retrain the current model. Ideally, one would like to take the data that has already been used to train the model (N examples), add the new set of examples (N_{new} examples) and train the model again with the N+N_{new} examples. The number of examples, however, increases very rapidly as time passes, and therefore it is a problem to fit all the data in memory, and it is also computationally very hard to train models.

Because of this, many techniques have been developed to reduce the amount of data used to retrain a model while still capturing the most relevant information from the large dataset. The most common method utilized for coping with the infeasibility of learning from very large data sets is sampling—the selection of a small sample from the dataset. Another approach is decomposing the data and run processes over these subsets of data in parallel. Still another approach is to use incremental batch learners that process subsamples of examples in sequence to learn from large training sets. Although these techniques, in practice, obtain good results in terms of performance, they may cause a decrease in accuracy, and retraining with large datasets is still difficult.

### SUMMARY OF THE INVENTION

Systems and methods for constructing and retraining decision tree ensembles via hybrid classical-quantum algorithms are disclosed. According to an embodiment, a method may include: (1) receiving, by a classical computer program, a dataset comprising a plurality of original examples, a plurality of new examples, a plurality of parameters, and a selection of a feature-weight calculation method; (2) calculating, by the classical computer program, feature-weights for the original examples using the feature-weight calculation method; (3) updating, by the classical computer program, the feature-weights for the original examples with feature-weights for the original examples and the new examples; (4) overwriting, by the classical computer program, values stored in classical memory based on the updated feature-weights; (5) loading, by the classical computer program, the feature-weights for the dataset and new data into a first quantum-accessible data structure; (6) loading, by the classical computer program, the overwritten values stored in classical memory into a second quantum-accessible data structure; (7) for a number of decision trees, instructing, by the classical computer program, a quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and/or a classification task; and (8) receiving, by the classical computer program, the labels from the quantum computer.

In one embodiment, the feature-weight calculation method comprises calculation of a Pearson correlation.

In one embodiment, a method for calculating the Pearson correlation comprises: calculating, by the classical computer program, the Pearson correlation for features in the original examples; and updating, by the classical computer program, the Pearson correlation for the original examples with the Pearson correlation for the original examples and the new examples.

In one embodiment, the feature-weight calculation method comprises calculation of a correlation ratio.

In one embodiment, a method for calculating the correlation ratio comprises: calculating, by the classical computer program, the correlation ratio for features in the original examples; and updating, by the classical computer program, the correlation ratio for the original examples with the Pearson correlation for the original examples and the new examples.

In one embodiment, the feature-weight calculation method is based on a task for the dataset.

In one embodiment, the quantum-supervised clustering creates a specified number of clusters.

According to another embodiment, a system may include: a quantum computer; and a classical computer comprising a computer processor and executing a classical computer program, wherein the classical computer program is configured to receive a dataset comprising a plurality of original examples, a plurality of new examples, a plurality of parameters, and a selection of a feature-weight calculation method, to calculate feature-weights for the original examples using the feature-weight calculation method, to update the feature-weights for the original examples with feature-weights for the original examples and the new examples, to overwrite values stored in classical memory based on the updated feature-weights, to load the feature-weights for the dataset and new data into a first quantum-accessible data structure, to load the overwritten values stored in classical memory into a second quantum-accessible data structure, for a number of decision trees, to instruct the quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and a classification task, and to receive the labels from the quantum computer.

In one embodiment, the feature-weight calculation method comprises calculation of a Pearson correlation.

In one embodiment, the classical computer program is configured to calculate the Pearson correlation by calculating the Pearson correlation for features in the original examples, and updating the Pearson correlation for the original examples with the Pearson correlation for the original examples and the new examples.

In one embodiment, the feature-weight calculation method comprises calculation of a correlation ratio.

In one embodiment, the classical computer program is configured to calculate the correlation ratio by calculating the correlation ratio for features in the original examples, and updating the correlation ratio for the original examples with the Pearson correlation for the original examples and the new examples.

In one embodiment, the feature-weight calculation method is based on a task for the dataset.

In one embodiment, the quantum-supervised clustering creates a specified number of clusters.

According to another embodiment, a non-transitory computer readable storage medium may include instructions stored thereon, which when read and executed by one or more computer processors, cause the one or more computer processors to perform steps comprising: receiving a dataset comprising a plurality of original examples, a plurality of new examples, a plurality of parameters, and a selection of a feature-weight calculation method; calculating feature-weights for the original examples using the feature-weight calculation method; updating the feature-weights for the original examples with feature-weights for the original examples and the new examples; overwriting values stored in classical memory based on the updated feature-weights; loading the feature-weights for the dataset and new data into a first quantum-accessible data structure; loading the overwritten values stored in classical memory into a second quantum-accessible data structure; for a number of decision trees, instructing a quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and a classification task; and receiving the labels from the quantum computer.

In one embodiment, the feature-weight calculation method comprises calculation of a Pearson correlation.

In one embodiment, the non-transitory computer readable storage medium may also include instructions stored thereon, which when read and executed by one or more computer processors, cause the one or more computer processors to perform steps comprising: calculating the Pearson correlation for features in the original examples; and updating the Pearson correlation for the original examples with the Pearson correlation for the original examples and the new examples.

In one embodiment, the feature-weight calculation method comprises calculation of a correlation ratio.

In one embodiment, the non-transitory computer readable storage medium may also include instructions stored thereon, which when read and executed by one or more computer processors, cause the one or more computer processors to perform steps comprising: calculating the correlation ratio for features in the original examples; and updating the correlation ratio for the original examples with the Pearson correlation for the original examples and the new examples.

In one embodiment, the feature-weight calculation method is based on a task for the dataset.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for construction and retraining of decision trees ensemble using hybrid classical-quantum algorithms according to an embodiment;

FIG. 2 illustrates a method for construction and retraining of decision trees ensemble using hybrid classical-quantum algorithms according to an embodiment;

FIG. 3 illustrates a method of calculating the Pearson correlation for the features using the original examples according to an embodiment;

FIG. 4 illustrates a method of updating the Pearson correlation for the original and new examples according to an embodiment;

FIG. 5 method for calculating a correlation ratio for the features using the original examples according to an embodiment;

FIG. 6 illustrates a method of updating the correlation ratio for the original and new examples according to an embodiment; and

FIG. 7 depicts an exemplary computing system for implementing aspects of the present disclosure.

### DETAILED DESCRIPTION OF PREFERRED EMBODIMENTS

Embodiments relate to systems and methods for construction and retraining of decision trees ensemble using hybrid classical-quantum algorithms.

The disclosures of U.S. patent application Ser. No. 18/448,662 and of the publication to Niraj Kumar, Romina Yalovetzky, Changhao Li, Pierre Minnsen, and Marco Pistoia entitled “Des-Q: A Quantum Algorithm To Construct And Efficiently Retrain Decision Trees For Regression And Binary Classification,” available at arXiv:2309.09976 (2023) are hereby incorporated, by reference, in their entireties.

The following variables and terms are used herein.

N is the total number of examples used to construct the ensemble of decision trees the first time (i.e., to first build the model with large data).

N_{new} refers to a new number of examples that are used in retraining (e.g., to retrain the model with incremental batches of data with N_{new} examples. Relative to N, N_{new} is a small number (e.g., N may include a week's worth of data). The model may be retrained with N+N_{new}. Later, a second set of new data, such as N_{new2} is received, and the model is retrained with N+N_{new}+N_{new2}. The process may continue as new data is identified.

d is the number of features.

[symbol] refers to an upper bound on the complexity of the algorithm. This may also refer to time.

W refers to all the feature-weights, meaning for all the features. For a feature, the weight; refers to the weight of the feature j. W is the set of all weights, i.e., {w₀, w₁, . . . , w_{d}}. Feature-weights capture how much a feature influences or has an impact over the labels. It gives an idea of how important a feature is towards the prediction. The feature-weights may define a weighted distance notion.

D is maximum tree depth.

k is the number of clusters, such as the number of children of each node of the tree.

c is the number of classes in the data.

The infeasibility of training models with large data from the time consumption perspective directly comes from the time that takes to train the model using the state-of-the-art techniques intended to be run solely on classical computers. Thus, embodiments are directed to the use of an ensemble of decision trees. Standard techniques to construct an ensemble of trees, such as random forest, scale linearly with the number of examples, making them unsuitable to train with large datasets.

Embodiments are directed to a hybrid classical-quantum algorithm that constructs and retrains single decision trees that addresses multi-class classification, supports categorical feature, creates an ensemble of trees, and outputs a classical representation of each of the trees in the ensemble. The output may include the centroids corresponding to each internal node in the t-th tree and the leaf information. In the case of regression, the leaf information may include the mean of the labels of the samples in the leaf node. For classification, embodiments may efficiently (e.g., scaling in polylog(N)) output the probability of each class in each of the leaf nodes of the T trees of the ensemble, allowing for statistical calculations to finally output the classified label for an unseen example.

For example, let D={(xₙ, yₙ)}ₙ₌₁^{N}∈ [symbol] ^{d}x{l₁, . . . l_{c}} for c classes or labels. In order to create the tree, embodiments may calculate feature-weights using the original examples—the N examples and vectors of size d, whose elements are the values of the features in that example, and their corresponding labels. These weights capture how much each feature, relative to the rest, influence the predictions. The feature-weights may be used to define a weighted distance notion as described below. The distance may be used in quantum clustering of the training and during inference, where a new example is inputted to the tree and the path that the example takes through the tree until reaching a leaf is identified. Note that the inference is done on the classical computer, and the construction and retraining of the tree is done in a hybrid quantum-classical fashion.

The distance calculated between a training example xi and each of the l centroids at iteration t, cₗ^{t} wⱼ corresponds to the feature-weight for the j-th feature.

This distance is defined as below:

$${‖ {x}_{i} - {c}_{1}^{t} ‖}_{w} = \sqrt{{\sum }_{j = 1}^{d} {w}_{j} \cdot {( {x}_{ij} - {c}_{lj}^{t} )}^{2}}$$

The Pearson correlation may be used to calculate the feature-weights. For binary classification, this correlation takes the name of point-biseral. Pearson correlation, however, cannot be applied to multi-class classification. Instead, the η coefficient, also known as correlation ratio, may be applied to multi-class classification. In embodiments, the feature-weights for multi-class classification may be calculated using the η coefficient, and Pearson correlation may be used for binary cases and for regression tasks.

When categorical features (i.e., features that are not continuous values such as the name of a country) are included in the data, an encoding technique may be used to convert the categorical features to numerical values. These values may not be continuous but may be discrete. Because of this, Pearson correlation cannot be used as it assumes continuous features. In contrast, the η coefficient supports discrete values. Therefore, the calculation of the feature-weights with this coefficient is desired when categorical features are involved, and the task is multi-class classification.

The correlations—one for each feature in the data—may be calculated on the classical computer. Thus, embodiments provide a hybrid classical-quantum algorithm.

Embodiments may construct and retrain an ensemble of trees using a method that is general and may be used in many different settings. Embodiments may be used for the tasks of regression and binary and multi-class classification and may support both numerical and categorical features.

Embodiments are directed to a hybrid quantum-classical method that allows for effective retraining, with a complexity that scales poly logarithmically in the number of the original examples utilized to construct the tree, N examples. This is an exponential speedup in comparison to standard purely classical methods as they scale linear in N. Because of this, embodiments may be utilized to do efficient frequent retraining of the ensemble of trees over large data. This large data is the result of the accumulation of training examples over time. Embodiments start the construction of the tree with a large dataset of original examples (N), and may periodically or continuously add new examples (N_{new}) examples.

Embodiments may directly train the models with all the data available instead of relying on techniques to reduce the data while preserving the most relevant information. Embodiments scale poly logarithmically in N. There is no overhead caused by the other parameters that may destroy the speedup. In terms of inference, if the trees in the ensemble are shallow, this is also an advantage because the time to do inference, i.e., the classification or regression of an unseen example, scale linear in the depth of the tree D.

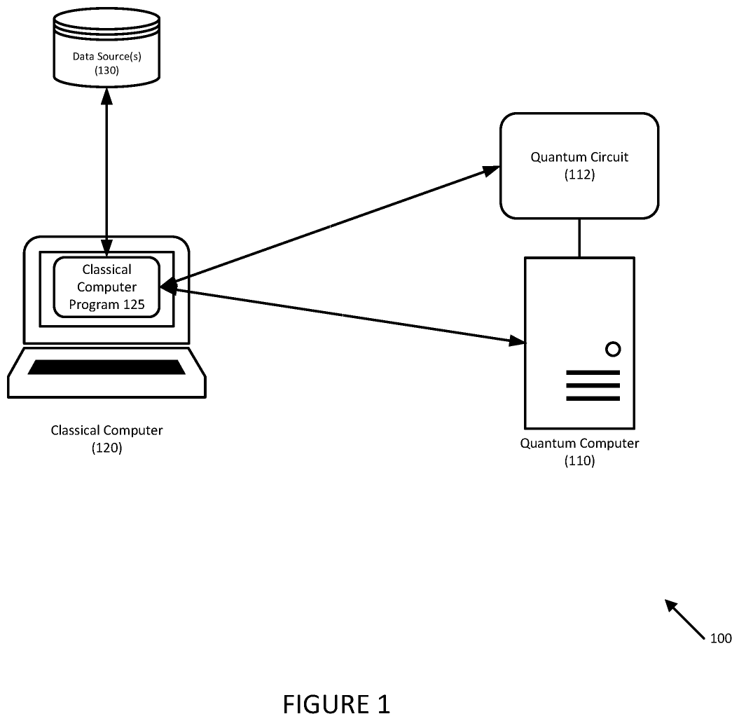

Referring to FIG. 1, a system for construction and retraining of decision trees ensemble using hybrid classical-quantum algorithms is disclosed according to an embodiment. System 100 may include quantum computer 110 that may execute quantum circuit 112. Quantum computer 110 may be a device that performs quantum computations, such as those based on the collective properties of quantum states including superposition, interference, and entanglement.

Classical computer 120 may be any suitable general purpose computing device, including servers, workstations, desktop, notebook, laptop, or tablet computers, etc. For example, classical computer 120 may be a microprocessor-based device. Classical computer 120 may interface with quantum circuit 112 using classical computer program 125, which may provide input to, and receive output from, quantum computer 110. In one embodiment, classical computer program 125 may generate one or more quantum circuits 112, may transpile the quantum circuit(s) 112 to machine-readable instructions, and may then send the transpiled circuit(s) 112 to quantum computer 110 for execution. Classical computer program 125 may also receive the results of the execution of the one or more quantum circuits 112.

Data source(s) 130 may include one or more sources of data. For example, data source(s) 130 may provide input data, such original examples and new examples. In embodiments, the decision tree may be used to classify a certain type of event (for example, credit card transactions). For example, the data may include a number of training examples containing historical data, such as information about previous events, and labels, or classifications, for those training examples. In the credit card example, the training example may include features such as the cardholder's name, age, etc. These events have already been classified, in most of the cases by a person, and they have assigned a label (e.g., fraud or not fraud).

In one embodiment, the data may further include categorical data.

It should be noted that the training examples are not limited to credit card transactions. Other training examples for other events may be used as is necessary and/or desired.

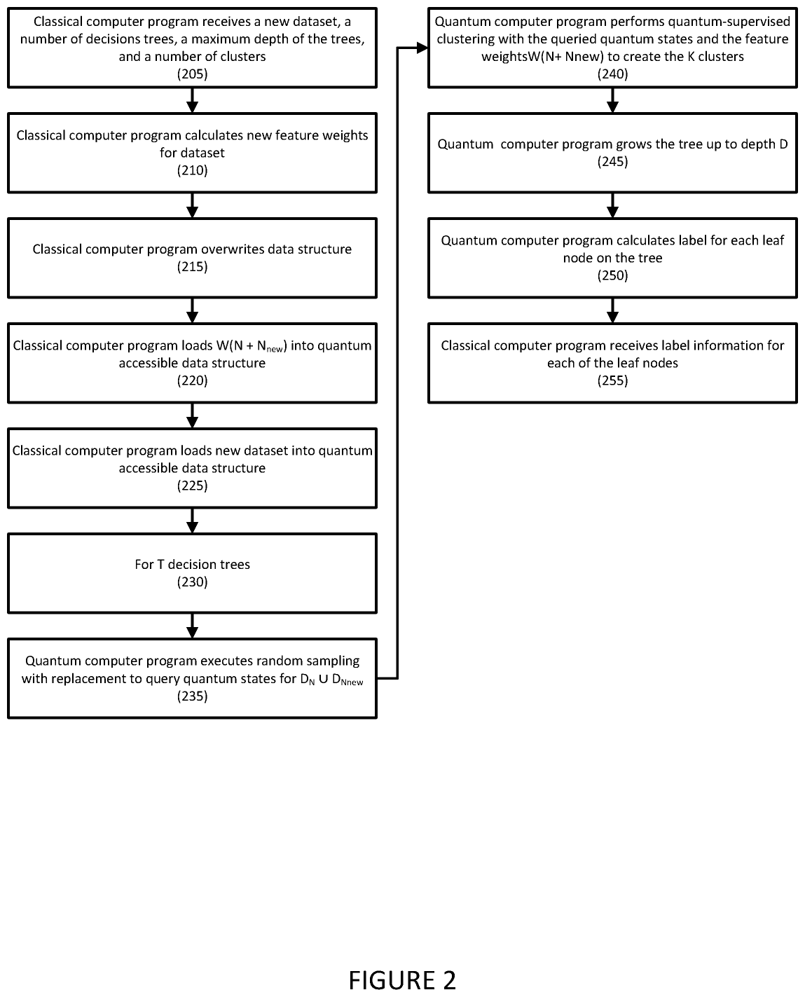

Referring to FIG. 2, a method for decision tree construction using hybrid classical-quantum algorithms is disclosed according to an embodiment.

In step 205, a classical computer program may receive a dataset Data_{Nnew}={(xₙ, yₙ)}_{n=N+1}^{Nnew}∈ [symbol] ^{d}x{l₁, . . . l_{c}} and parameters, such as a number of decision trees in the ensemble T, a maximum depth of the trees D, and a number of clusters K. In one embodiment, a user may provide the parameters; in another embodiment, the parameters may be determined based on the data size and/or data type. The dataset may include both original examples and new examples.

In one embodiment, the classical computer program may also receive a selection of a feature-weight calculation method for the new feature-weights. For example, the classical computer program may receive a selection to use the Pearson correlation or the correlation ratio (the “η coefficient”). For example, if the task is multi class classification, embodiments may select the correlation ratio. If the task is either binary classification or regression and the features are only numerical, both the Pearson correlation and the correlation ratio may be used. For all tasks, if there are categorical features, the Pearson correlation is used.

In step 210, a classical computer program may classically calculate the feature-weights for the original examples and the new examples, as W(N+N_{new})=wⱼ(N+N_{new}) utilizing I_{W(N)}, which contains some information that is used to calculate W (N).

The information that is used may depend on the method used to calculate the feature-weights. In embodiments, two methods may be used to calculate the feature-weights: the Pearson correlation and the correlation ratio. Thus, embodiments may find application in the setting of frequent retraining because they leverage the calculation of these weights in considering a set of data of N examples, some information about the weights is stored, and then in order to calculate the weights for the N+N_{new} examples, that information may be used so the complexity of this calculation scales linear in N_{new} and it is independent of N.

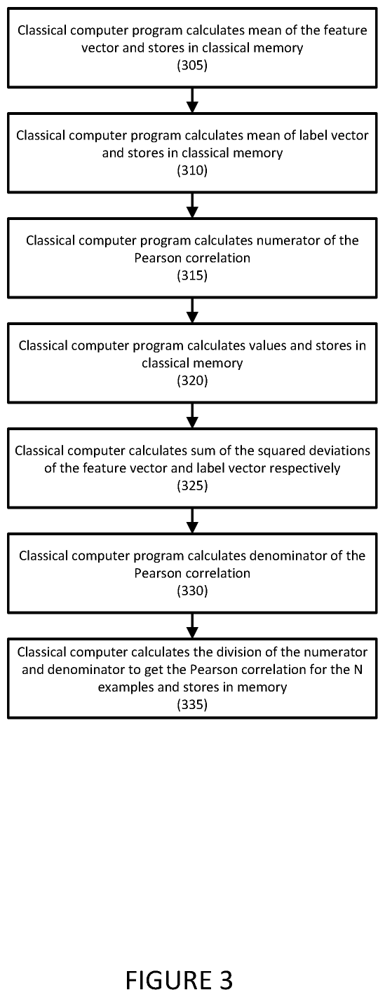

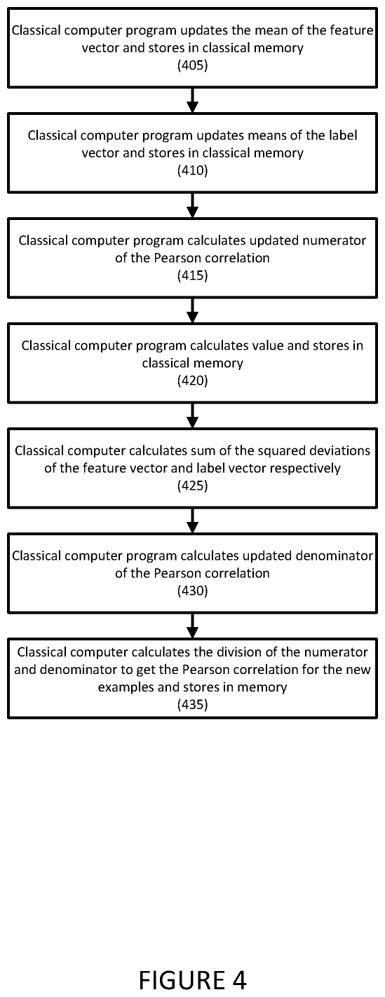

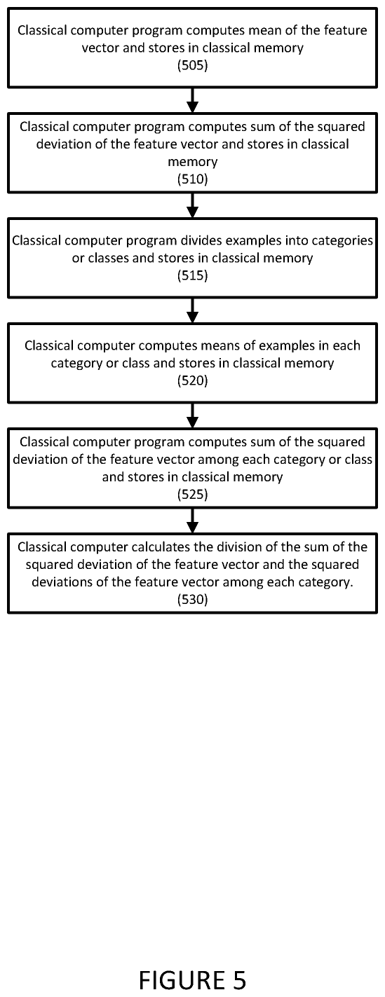

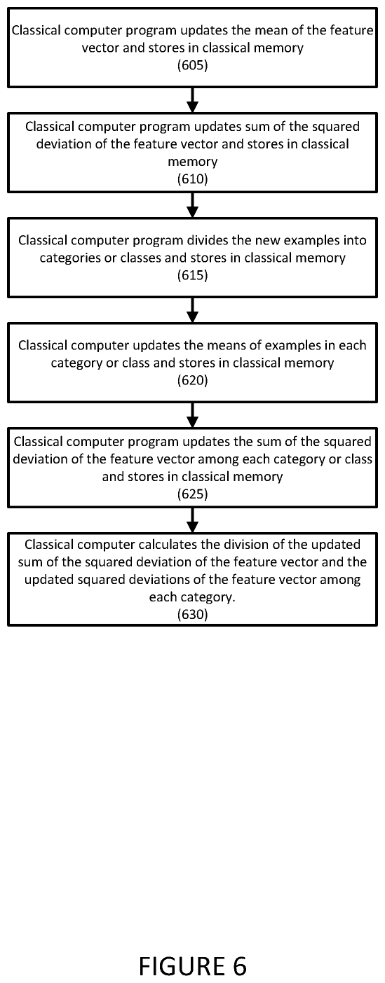

If the Pearson correlation is used, the process continues to FIGS. 3 and 4. If the correlation ratio is used, the process continues to FIGS. 5 and 6.

FIG. 3 illustrates a method of calculating the Pearson correlation for the features using the original examples according to an embodiment. The process may be repeated for the d features.

In step 305, the classical computer program may compute the mean of the feature vector j:

$${μ}_{j} = \frac{1}{N} {\sum }_{i = 1}^{N} {x}_{ij} .$$

The mean may be stored in classical memory.

In step 310, the classical computer program may compute the mean of the label vector

$${μ}_{y} = \frac{1}{N} {\sum }_{i = 1}^{N} {y}_{j} .$$

The mean may be stored in classical memory.

In step 315, the classical computer program may calculate the numerator of the Pearson coefficient as:

$$num = {\sum }_{i = 1}^{N} {x}_{ij} {y}_{i} - 2 {μ}_{j} {μ}_{y} N + N {μ}_{j}^{2}$$

In step 320, the classical computer program may calculate a value Σᵢ₌₁^{N}xᵢⱼyⱼ and may store the value in classical memory.

In step 325, the classical computer program may calculate the sum of the squared deviations of the feature vector and label vector, respectively.

In step 330, the classical computer program may calculate the denominator of the Pearson correlation as the multiplication of the root-square of the sum of the squared deviations of the feature vector and the label vector, respectively:

$$den = \sqrt{{SS}_{T}^{j}} \sqrt{{SS}_{y}^{j}}$$

In step 335, the classical computer program may calculate the division of the numerator and denominator to get the Pearson correlation for the N examples and may store the Pearson correlation in classical memory.

As part of the calculation of the Pearson correlation for all the d features, values μⱼ, μ_{y}, and Σᵢ₌₁^{N}xᵢⱼyⱼ have been calculated. These values may be referred to as D_{W(N)}. The complexity in memory is [symbol] (d). These quantities will be used as part of the update in the process depicted in FIG. 4.

For example, the Pearson correlation for the j-th feature is defined as:

$${w}_{j} = \frac{{\sum }_{i = 1}^{N} ( {x}_{ij} - {μ}_{j} ) ( {y}_{i} - {μ}_{y} )}{\sqrt{{\sum }_{i = 1}^{N} {( {x}_{ij} - {μ}_{j} )}^{2}} \sqrt{{\sum }_{i = 1}^{N} {( {y}_{i} - {μ}_{y} )}^{2}}}$$

where

$${μ}_{j} = \frac{1}{N} {\sum }_{i = 1}^{N} {x}_{ij}$$

is the mean over the feature vector and

$${μ}_{y} = \frac{1}{N} {\sum }_{i = 1}^{N} {y}_{i}$$

is the where mean over the label vector.

Referring to FIG. 4, once the Pearson correlation is calculated for the N examples, it may be updated for the N+N_{new} examples.

FIG. 4 illustrates a method of updating the Pearson correlation for the original and new examples according to an embodiment. For example, for the new data N_{new}, the Pearson correlation corresponding to the N+N_{new} examples may be calculated. Its complexity is [symbol] (Ñd). The process may be repeated for the d features.

In step 405, given the stored μⱼ (previously computed with N examples), the classical computer program may calculate the mean for N+N_{new} examples as

$${μ}_{j}^{tot} = \frac{N μ j + {N}_{new} {μ}_{j}^{′}}{N + {N}_{new}} ,$$

where μ′ⱼ is the mean of N_{new} examples. It only requires the calculation of μ′ⱼ The mean may be stored in classical memory. This operation takes time [symbol] (N_{new}d) for all the features.

In step 410, the classical computer program may update the mean of the labels μ_{y}^{tot}. The mean may be stored in classical memory.

In step 415, the classical computer program may update the numerator of the Pearson correlation by updating the second term in the equation:

$${num}^{tot} = {\sum }_{i = 1}^{N} {x}_{ij} {y}_{i} + {\sum }_{i = N + 1}^{\tilde{N}} {x}_{ij} {y}_{i} - 2 {μ}_{j}^{tot} {μ}_{y}^{tot} ( N + \tilde{N} ) + ( N + \tilde{N} ) {( {μ}_{j}^{tot} )}^{2}$$

The calculation takes time [symbol] (N_{new}).

In step 420, the classical computer program may calculate a value Σᵢ₌₁^{N}^{_{new}}xᵢⱼyⱼ for the new examples and may store the value in classical memory.

In step 425, the classical computer program may calculate the sum of the squared deviations of the feature vector and label vector, respectively.

In step 430, the classical computer program may update the denominator of the Pearson correlation by updating SS_{T}^{j} and SS_{y}^{j}:

$${den}^{tot} = \sqrt{{SS}_{T}^{( j , tot )}} \sqrt{{SS}_{y}^{( j , tot )}}$$

SS_{T}^{j} may be updated in the same way as in step 330, above. SS_{y}^{j}: may be updated similarly, also taking [symbol] (N_{new}) time to calculate Σ_{i=N+1}^{N}^{_{new}}yᵢ².

In step 435, may calculate the division of the numerator and denominator to get the Pearson correlation for the N+N_{new} examples and may store the Pearson correlation in classical memory.

Referring back to FIG. 2, in step 215, the classical computer program may overwrite D_{W(N)} stored on classical data structure with D_{W}(N+N_{new}) containing some information utilized to calculate the new features weights W(N+N_{new}).

FIG. 5 method for calculating the correlation ratio for the features using the original examples according to an embodiment. In one embodiment, the correlation ratio n may be defined as for the j-th feature as follows:

$${η}_{j}^{2} = \frac{{SS}_{cat}^{j}}{{SS}_{tot}^{j}}$$

$$where$$

$${SS}_{cat}^{j} = {\sum }_{l = {l}_{1}}^{{l}_{c}} {{N}_{l} ( {μ}_{j , l} - {μ}_{j} )}^{2} , {SS}_{tot}^{j} = {\sum }_{i = 1}^{N} {( {x}_{ij} - {μ}_{j} )}^{2}$$

SSₜₒₜ^{j} is the sum of the squared deviations for the vector of the j-th feature and SS_{cat}^{j} is the sum of the squared deviations for the vector of the j-th feature among the categories (or classes).

For the j-th feature, ηⱼ may be calculated as follows. For all the features, this process takes time [symbol] (Ndc).

In step 505, the classical computer program may compute the mean of the feature vector j:

$${μ}_{j} = \frac{1}{N} {\sum }_{i = 1}^{N} {x}_{ij}$$

and may store the mean in classical memory.

In step 510, the classical computer program may compute the sum of the squared deviation of the feature vector: SSᵢ₋₁^{(j)}=Σᵢ₌₁^{N}(xᵢⱼ−μⱼ)²=Σxᵢⱼ²−Nμⱼ² and may store the sum of the squared deviation of the feature vector in classical memory.

In step 515, the classical computer program may divide the N examples into c lasses or categories such that each individual category has the same target label: {Nₗ₁, . . . , N_{lc}}. The division may be stored in classical memory.

In step 520, the classical computer program may compute the means of the examples in each category μⱼₗ where l∈{l₁, . . . , l_{c}} and may store the mean in classical memory.

In step 525, the classical computer program may compute the sum of squared deviation among the categories: SS_{M}^{(j)}=Σₗ₌₁^{c}Nⱼₗ(μⱼₗ−μⱼ)² and may store the sum of the squared deviation of the feature vector in classical memory.

In step 530, the classical computer program may calculate the division of the sum of the squared deviation of the feature vector and the squared deviations of the feature vector among each category. This results in the η coefficient for the N examples. The η coefficient may be stored in classical memory.

For example, the classical computer program may calculate the n coefficient for each feature j as

$${η}_{j} = √ \frac{{SS}_{M}^{( j )}}{{SS}_{T}^{( j )}} .$$

As part of the steps to calculate the correlation ratio, the following values may be stored in classical memory: μⱼ, SS_{T}^{(j)}, {Nₗ₁, . . . , N_{lc}}, and SS_{cat}^{j}. The information stored in memory may be referred to as D_{W(N)}. The complexity in memory is [symbol] (d×c).

FIG. 6 illustrates a method of updating the correlation ratio for the original and new examples according to an embodiment. This method takes time [symbol] (N_{new}dc).

In step 605, given the stored μⱼ (previously computed with N examples), the classical computer program may update the mean for N+N_{new} examples, named μⱼ^{tot}, as

$${μ}_{j}^{tot} = \frac{N μ j + {N}_{new} {μ}_{j}^{′}}{N + {N}_{new}} ,$$

where μ′ⱼ is the mean of N_{new} examples. It only requires the calculation of μ′ⱼ and simple arithmetic calculations. This operation takes time [symbol] (N_{newd}) for all the features.

In step 610, the classical computer program may update the sum of squared deviations for N+N_{new} examples as follows:

$$\begin{matrix}{SS}_{T}^{( j , tot )} = {\sum }_{i = 1}^{N + N} {( {x}_{ij} - {μ}_{j}^{tot} )}^{2} \\ = {\sum }_{i = 1}^{N + \tilde{N}} ( {x}_{ij}^{2} + {( {μ}_{j}^{tot} )}^{2} - 2 {x}_{ij} {μ}_{j}^{tot} ) \\ = {\sum }_{i = 1}^{N + \tilde{N}} {x}_{ij}^{2} - ( N + \tilde{N} ) {( {μ}_{j}^{tot} )}^{2} \\ = {\sum }_{i = 1}^{N} {x}_{ij}^{2} + {\sum }_{i = 1}^{\tilde{N}} {x}_{ij}^{2} - ( N + \tilde{N} ) {( {μ}_{j}^{tot} )}^{2} \\ = {SS}_{T}^{( j )} + {N ( {μ}_{j}^{tot} )}^{2} + {\sum }_{i = 1}^{\tilde{N}} {x}_{j}^{2} - ( N + \tilde{N} ) {( {μ}_{j}^{tot} )}^{2}\end{matrix}$$

From the above equation, the only thing that is unknown is Σᵢ₌₁^{Ñ}xᵢⱼ² which can be computed for new examples in time [symbol] (N_{new}).

In step 615, the classical computer program may divide the new examples into categories or classes and may store the division in classical memory.

In step 620, the classical computer program may update the means of each class and denote them as μⱼ^{tot} for all j∈[d], l∈c.

In step 625, the classical computer program may calculate SS_{M}^{(j,tot)} in time [symbol] (c) given the calculations of μⱼₗ^{tot} and Nⱼₗ^{tot} above.

In step 630, the classical computer program may calculate the division of the updated sum of the squared deviation of the feature vector and the updated squared deviations of the feature vector among each category. This results in the η coefficient for the N_{new} examples. The η coefficient may be stored in classical memory.

Referring back to FIG. 2, in step 215, the classical computer program may overwrite D_{W(N)} stored on classical data structure with D_{W}(N+N_{new}) containing some information utilized to calculate the new features weights W(N+N_{new}).

In step 220, the classical computer program may load W (N+N_{new}) using a quantum-accessible data structure.

Embodiments may perform frequent retraining of the ensemble of trees model when there is access to a new small batch of data N_{new}. This structure cannot fit data to infinity, so some of the old examples stored in that data structure may be removed.

In step 225, the classical computer program may load D_{Nnew} using a quantum-accessible data structure.

In step 230, the quantum computer program may iterate from 1 to T, the number of decision trees. It should be noted that steps 235-250 may be executed sequentially, in parallel, etc., depending on the quantum resources that are available.

In step 235, the quantum computer program may execute random sampling with replacement to efficiently query the quantum states for the examples D_{N}∪D_{Nnew}. These values are used to build the t-th tree of the ensemble.

In step 240, the quantum computer program may perform quantum-supervised clustering with the queried quantum states and the feature-weights W (N+N_{new}) to create the k clusters.

In step 245, the quantum computer program may grow the tree up to depth D. At each depth, the centroids {c_{node}∈ [symbol] ^{d}} node for the nodes at given depth may be stored.

In step 250, for each leaf node, the quantum computer program may calculate {labelⱼ}_{j∈[k}_{^{D}}_{]} for the regression task and {p_{j,l}}_{j∈[k}_{^{D}}_{], l∈[lc]} for classification task. Each label node of a tree contains the samples assigned to the node during training. For classification task, the probability of each of the classes of the labels of the samples is calculated. For regression, the mean of the labels of the samples is calculated. The procedure may be repeated for all leaf nodes and for all the trees in the ensemble. The quantum computer returns these values.

For example, after construction of the t-th tree of the ensemble, the tree has k^{D} leaf nodes with training samples assigned to i. For the t-th tree, the samples may be referred to as the set [symbol] ⱼ^{t}, j∈[k^{D}], t∈[T]. For each of the leaf nodes, the algorithm outputs from the quantum computer a classical representation the mean of the label values, meanⱼ, for the regression task, and the probability of each of the classes or labels in the data, p_{j,l}, for the classification task:

$${mean}_{j} = \frac{1}{\vert {C}_{j} \vert} {\sum }_{i ∈ {C}_{j}} yi {p}_{i , l} = \frac{{N}_{j , 1}}{{N}_{j}}$$

where N_{j,l} is the number of samples in the j-th cluster, [symbol] ⱼ, with label lₗ and Nⱼ is the total number of samples in that node.

For classification, having classical access to the probability of each class in each of the leaf nodes of the T trees in the ensemble allows for a variety of statistical calculations to determine the label to be output by the ensemble. This contribution allows for multiclass classification.

In step 255, the classical computer program may receive label information for each of the leaf nodes.

In one embodiment, the classical computer receives, from the quantum computer, the classical representation of the structure of all trees in the ensemble. The structure of each tree consists of the label information for each of the leaf nodes, which may be either of the two magnitudes the centroids (vectors) for each of the internal nodes of the tree.

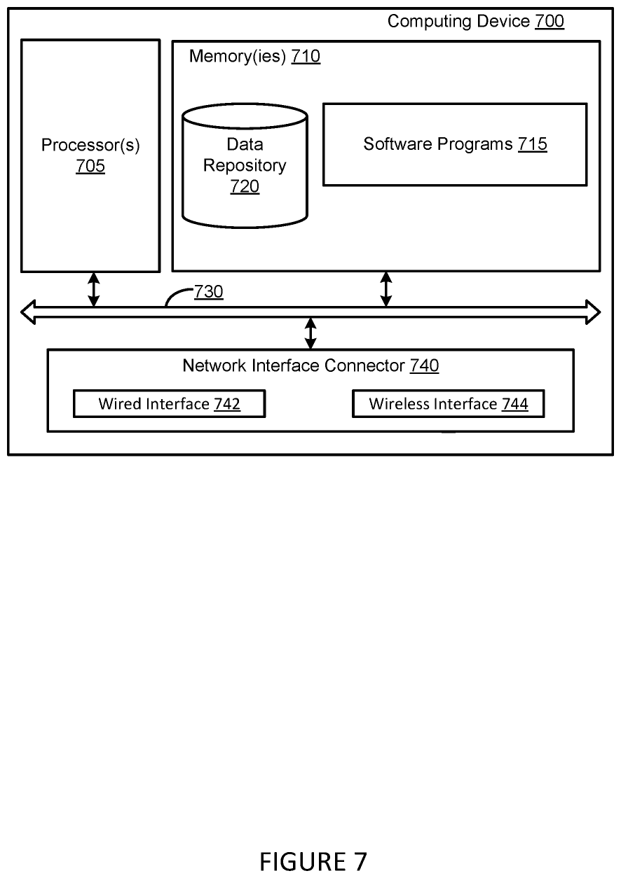

FIG. 7 depicts an exemplary computing system for implementing aspects of the present disclosure. FIG. 7 depicts exemplary computing device 700. Computing device 700 may represent the system components described herein. Computing device 700 may include processor 705 that may be coupled to memory 710. Memory 710 may include volatile memory. Processor 705 may execute computer-executable program code stored in memory 710, such as software programs 715. Software programs 715 may include one or more of the logical steps disclosed herein as a programmatic instruction, which may be executed by processor 705. Memory 710 may also include data repository 720, which may be nonvolatile memory for data persistence. Processor 705 and memory 710 may be coupled by bus 730. Bus 730 may also be coupled to one or more network interface connectors 740, such as wired network interface 742 or wireless network interface 744. Computing device 700 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a classical computer program, a dataset comprising a plurality of original examples, a plurality of new examples, a plurality of parameters, and a selection of a feature-weight calculation method;
calculating, by the classical computer program, feature-weights for the original examples using the feature-weight calculation method;
updating, by the classical computer program, the feature-weights for the original examples with feature-weights for the original examples and the new examples;
overwriting, by the classical computer program, values stored in classical memory based on the updated feature-weights;
loading, by the classical computer program, the feature-weights for the dataset and new data into a first quantum-accessible data structure;
loading, by the classical computer program, the overwritten values stored in classical memory into a second quantum-accessible data structure;
for a number of decision trees, instructing, by the classical computer program, a quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and/or a classification task; and
receiving, by the classical computer program, the labels from the quantum computer.

2. The method of claim 1, wherein the feature-weight calculation method comprises calculation of a Pearson correlation.

3. The method of claim 2, wherein a method for calculating the Pearson correlation comprises:
calculating, by the classical computer program, the Pearson correlation for features in the original examples; and
updating, by the classical computer program, the Pearson correlation for the original examples with the Pearson correlation for the original examples and the new examples.

4. The method of claim 1, wherein the feature-weight calculation method comprises calculation of a correlation ratio.

5. The method of claim 4, wherein a method for calculating the correlation ratio comprises:
calculating, by the classical computer program, the correlation ratio for features in the original examples; and
updating, by the classical computer program, the correlation ratio for the original examples with the Pearson correlation for the original examples and the new examples.

6. The method of claim 1, wherein the feature-weight calculation method is based on a task for the dataset.

7. The method of claim 1, wherein the quantum-supervised clustering creates a specified number of clusters.

8. A system, comprising:
a quantum computer; and
a classical computer comprising a computer processor and executing a classical computer program, wherein the classical computer program is configured to receive a dataset comprising a plurality of original examples, a plurality of new examples, a plurality of parameters, and a selection of a feature-weight calculation method, to calculate feature-weights for the original examples using the feature-weight calculation method, to update the feature-weights for the original examples with feature-weights for the original examples and the new examples, to overwrite values stored in classical memory based on the updated feature-weights, to load the feature-weights for the dataset and new data into a first quantum-accessible data structure, to load the overwritten values stored in classical memory into a second quantum-accessible data structure, for a number of decision trees, to instruct the quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and a classification task, and to receive the labels from the quantum computer.

9. The system of claim 8, wherein the feature-weight calculation method comprises calculation of a Pearson correlation.

10. The system of claim 9, wherein the classical computer program is configured to calculate the Pearson correlation by calculating the Pearson correlation for features in the original examples, and updating the Pearson correlation for the original examples with the Pearson correlation for the original examples and the new examples.

11. The system of claim 8, wherein the feature-weight calculation method comprises calculation of a correlation ratio.

12. The system of claim 11, wherein the classical computer program is configured to calculate the correlation ratio by calculating the correlation ratio for features in the original examples, and updating the correlation ratio for the original examples with the Pearson correlation for the original examples and the new examples.

13. The system of claim 8, wherein the feature-weight calculation method is based on a task for the dataset.

14. The system of claim 8, wherein the quantum-supervised clustering creates a specified number of clusters.

15. A non-transitory computer readable storage medium, including instructions stored thereon, which when read and executed by one or more computer processors, cause the one or more computer processors to perform steps comprising:
receiving a dataset comprising a plurality of original examples, a plurality of new examples, a plurality of parameters, and a selection of a feature-weight calculation method;
calculating feature-weights for the original examples using the feature-weight calculation method;
updating the feature-weights for the original examples with feature-weights for the original examples and the new examples;
overwriting values stored in classical memory based on the updated feature-weights;
loading the feature-weights for the dataset and new data into a first quantum-accessible data structure;
loading the overwritten values stored in classical memory into a second quantum-accessible data structure;
for a number of decision trees, instructing a quantum computer to query quantum states for the first quantum-accessible data structure and the second quantum-accessible data structure for new examples using random sampling with replacement, to execute quantum-supervised clustering with the quantum states and the feature-weights for the dataset and new data, to grow a depth for the tree and to store a centroid at each depth, and to calculate labels for a regression task and a classification task; and
receiving the labels from the quantum computer.

16. The non-transitory computer readable storage medium of claim 15, wherein the feature-weight calculation method comprises calculation of a Pearson correlation.

17. The non-transitory computer readable storage medium of claim 16, further including instructions stored thereon, which when read and executed by one or more computer processors, cause the one or more computer processors to perform steps comprising:
calculating the Pearson correlation for features in the original examples; and
updating the Pearson correlation for the original examples with the Pearson correlation for the original examples and the new examples.

18. The non-transitory computer readable storage medium of claim 15, wherein the feature-weight calculation method comprises calculation of a correlation ratio.

19. The non-transitory computer readable storage medium of claim 18, further including instructions stored thereon, which when read and executed by one or more computer processors, cause the one or more computer processors to perform steps comprising:
calculating the correlation ratio for features in the original examples; and
updating the correlation ratio for the original examples with the Pearson correlation for the original examples and the new examples.

20. The non-transitory computer readable storage medium of claim 15, wherein the feature-weight calculation method is based on a task for the dataset.
